(19) United States
(12) Patent Application Publication
(10) Pub. No.: US 2006/0232716 A1
(43) Pub. Date: Oct. 19, 2006

(54) Projection system

(75) Inventors: Wen-Chang Chien, Chunan (TW); Lien-Fu Hu, Chunan (TW); Yen-Hsien Su, Chunan (TW)

Correspondence Address: BIRCH STEWART KOLASCH & BIRCH, PO BOX 747, FALLS CHURCH, VA, 22040-0747, US

(73) Assignee: Coretronic Corporation

(21) Appl. No.: 11/346,169

(22) Filed: Feb. 3, 2006

(30) Foreign Application Priority Data
Apr. 14, 2005 (TW) 94111872

(51) Int. Cl. H04N 9/31

(52) U.S. Cl. 348/744

(57) ABSTRACT

A projection system with a digital video data loading module and a digital video data processing module is provided. A digital video data loaded by the digital video data loading module is converted into a digital YUV color difference signal by the digital video data processing module and then transmitted to an image processing and projecting unit of the projection system for projection an image.

### RELATED APPLICATIONS

The present application is based on, and claims priority from, Taiwan Application Serial Number 94111872, filed Apr. 14, 2005, the disclosure of which is hereby incorporated by reference herein in its entirety.

### BACKGROUND

1. Field of Invention

The present invention relates to a projection system. More particularly, the present invention relates to a projection system with a built-in video signal source unit.

2. Description of Related Art

In general, a projection system, such as a projector or a rear projection television, is used for projecting images. The projection system additionally connects with an apparatus providing a video signal to display the images. Therefore, the projection system is designed to have various data signal interfaces of video standards for various applications.

FIG. 1 shows a block diagram of a conventional projection system 104 and a video signal source 102. The video signal source 102, such as a VCD player, a DVD player or a digital camera, is used to provide a video signal. The video signal is transmitted from the video signal source 102 to a projection system 104 via an external line 110. Due to analog video signal transmission standards of a conventional television system, such as composite, S-video and component i standards, being in widespread use, the video signal transmitted via the external line 110 is an analog video signal.

An image processing and projecting unit 108 is further included to process an external video signal and project an image. However, the signal input into the image processing and projecting unit 108 is the digital signal. A video decoder 106 in the conventional projection system 104 is used to convert the analog video signal transmitted by the external line 110 into the digital signal. Then, the digital signal can be transmitted into the image processing and projecting unit 108 for processing the digital signal and projection the image in accord with the digital signal.

According to the above-mentioned transmission flow path of the video signal, the digital video signal is converted into the analog video signal in the video signal source 102 before the signal is transmitted into the conventional projection system 104. Then, the analog video signal is converted back to the digital video signal before the subsequent processes is executed. In other words, the digital video signal is subjected to at least one digital/analog conversion and at least one analog/digital conversion. Each of the digital/analog conversion and analog/digital conversion can distort the converted signal. Thus, some of the video signal is lost after the video signal is converted twice, and a quality of the final projected image is degraded.

Because the conventional projection system is only used to project the image, and the video signal of the image is acquired from the external video signal source, both the projection system and the video signal source occupy a large space and are heavy in weight, greatly limiting the applicability of the projection system.

### SUMMARY

It is therefore an objective of the present invention to provide a projection system with a built-in video signal source unit.

It is another objective of the present invention to provide a projection system which is able to reduce image distortion.

It is still another objective of the present invention to provide a projection system with low cost.

It is another objective of the present invention to provide a projection system with small volume.

According to the foregoing objectives of the invention, a digital video signal source, such as a VCD or a DVD signal source, is built within a projection system. Thus, a digital video signal can be directly transmitted from the digital video signal source to the image processing and projecting unit of the projection system without the conversion by a video decoder, wherein the digital video signal is transmitted in the YUV color difference signal form.

In addition, a buffer can be disposed between the digital video signal source unit and the image processing and projecting unit to switch lines between the digital video signal source unit and the image processing and projecting unit such that the projection system can still receive and process an externally input video signal.

### BRIEF DESCRIPTION OF THE DRAWINGS

These and other features, aspects and advantages of the present invention will become better understood with regard to the following description, appended claims and accompanying drawings, where:

FIG. 1 illustrates a conventional projection system;

FIG. 2A illustrates a projection system according to an embodiment of the present invention; and

FIG. 2B illustrates a projection system according to the other embodiment of the present invention.

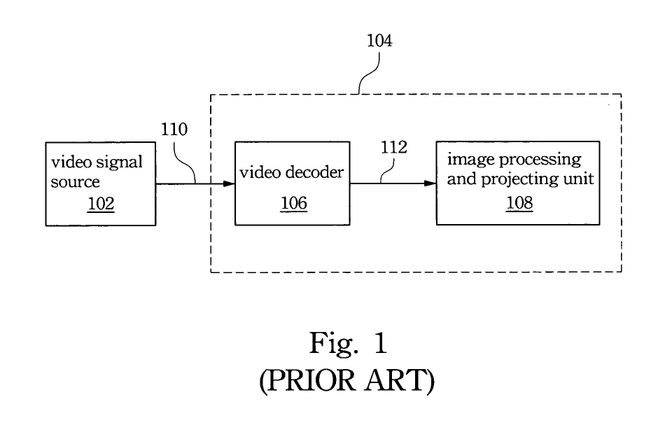

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

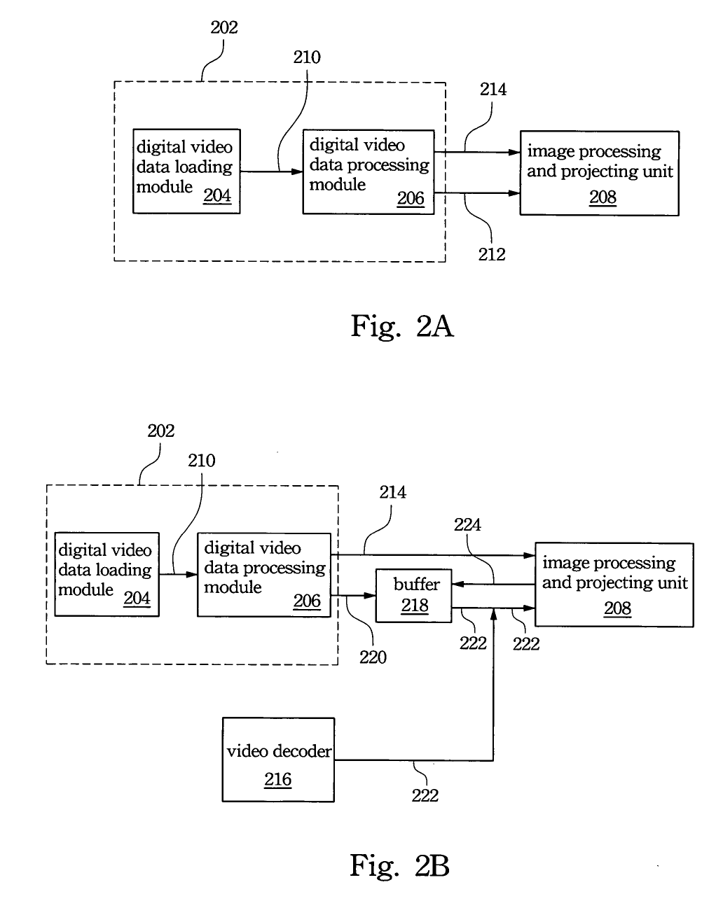

FIG. 2A illustrates a projection system according to an embodiment of the present invention. The projection system includes a digital video signal source 202 and an image processing and projecting unit 208, and the digital video signal source 202 includes a digital video data loading module 204 and a digital video data processing module 206.

The digital video data loading module 204 is able to receive various digital video data, such as the digital video data in accordance with VCD or DVD video standards, into the system, and then the loaded digital video data is transmitted to the digital video data processing module 206 via a line 210. The digital video data processing module 206 is able to convert the digital video data into a digital video signal being accepted by the image processing and projecting unit 208 via a line 212. The image processing and projecting unit 208 is able to project an image in accord with the digital video signal. In this embodiment, the digital video signal transmitted by the line 212 is transmitted in a digital YUV color difference signal form, such as a form in accordance with ITU. 601 standard or ITU. 656 standard.

According to transmission paths of the video data and the video signal, it can be seen that both the video data transmitted by the line 210 and the video signal transmitted by the line 212 are transmitted in digital form. That is to say, there is no digital/analog or analog/digital conversion. Thus, a quality of the image projected by the image processing and projecting unit 208 can be improved, and a cost of a video decoder can be avoided.

In addition, because the form of the signal transmitted in the projection system is based on the signal standard of the television system in general, the digital video signal transmitted by the line 212 is in the form in accordance with the YUV color difference signal standard, and the digital video signal is processed as a television signal by the image processing and projecting unit 208 to project the image. Many television image standards of the television signal are presently used, such as PAL and NTSC standards, wherein the PAL standard further comprises PAL 50 and PAL 60 standards. The image processing and projecting unit 208 first is programmed to recognize which a video image standard is used in the digital video signal so that the digital video signal can be properly processed and imaged.

In this embodiment, a notification line 214 is used to notify the image processing and projecting unit 208 of which the video image standard is being used in the digital video signal transmitted by the line 212. For example, if the above-mentioned NTSC, PAL 50 and PAL 60 standards can be used, the notification line 214 needs to have at least two bits act as a notification signal, wherein the signal “00” indicates that no signal is being transmitted, “01” indicates the PAL 50 standard, “10” indicates the NTSC or PAL 60 standard, and “11” is reserved. In the foregoing embodiment, a framework of the projection system with a built-in video signal source unit is provided.

A another projection system shown in FIG. 2B includes the video signal source unit 202, the digital video data loading module 204, the digital video data processing module 206 and the image processing and projecting unit 208. The purposes and the connections between these components are identical to those in the embodiment shown in FIG. 2A. In addition, a video decoder 216 is used to convert an analog video signal into a digital video signal. Hence, there are two sources, respectively from the digital video data processing module 206 and the video decoder 216, which can be used to provide a digital video signal for the image processing and projecting unit 208. In this embodiment, the digital video signal from the various sources is transmitted to the image processing and projecting unit 208 via a common line 222. A buffer 218 is disposed between the digital video data processing module 206 and the image processing and projecting unit 208 to control an output of the digital video data processing module 206 and prevent the signal transmitted by the common line 222 from becoming disordered when the digital video data processing module 206 and the video decoder 216 output signals to the image processing and projecting unit 208 at the same time.

In the embodiment, the digital video signal is first transmitted from the digital video data processing module 206 to the buffer 218 via the line 220. Then, the buffer 218 receives a control signal from the image processing and projecting unit 208 via a line 224 to determine on transmitting the digital video signal to the image processing and projecting unit 208 or not. When the buffer 218 is disabled, the image processing and projecting unit 208 only accepts a digital video signal input from the video decoder 216. When the buffer is enabled, the image processing and projecting unit 208 only accepts a digital video signal input from the digital video data processing module 206. (The video decoder usually has a built-in buffer.)

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A projection system, comprising:
a digital video data loading module used to provide a digital video data;
a digital video data processing module used to convert said digital video data into a digital video signal in accordance with a YUV color difference signal standard; and
an image processing and projecting unit used to process said digital video signal to project an image.

2. The projection system of claim 1, wherein said digital video data is in accordance with a VCD standard or a DVD standard.

3. The projection system of claim 1, wherein said YUV color difference signal standard is an ITU. 601 standard or an ITU. 656 standard.

4. The projection system of claim 1, wherein said digital video signal comprises television image standards being a NTSC standard, a PAL 50 standard or a PAL 60 standard.

5. The projection system of claim 4, further comprising a notification line connected between said digital video data processing module and said image processing and projecting unit, said digital video data processing module transmitting a notification signal to said image processing and projecting unit via said notification line to notify said image processing and projecting unit of which image standard is being used in said digital video signal.

6. The projection system of claim 5, wherein said notification signal comprises two bits.

7. The projection system of claim 1, wherein said projection system is a projector.

8. The projection system of claim 1, wherein said projection system is a rear projection television.

9. A projection system, comprising:
a digital video data loading module used to provide an internal digital video data;
a digital video data processing module used to convert said internal digital video data into an internal digital video signal, said internal digital video signal is in accordance with a YUV color difference signal standard;
a buffer used to control an output of said internal digital video signal;
a video decoder used to convert an external analog video signal into an external digital video signal; and
an image processing and projecting unit used to process said internal digital video signal output from said buffer or said external digital video signal output from said video decoder to project an image,
wherein said image processing and projecting unit uses a control signal to switch said buffer, and when said buffer is enabled, said buffer is able to output said internal digital video signal, and when said buffer is disabled, said buffer is unable to output said internal digital video signal.

10. The projection system of claim 9, wherein said internal digital video data is in accordance with a VCD standard or a DVD standard.

11. The projection system of claim 9, wherein said YUV color difference signal standard is an ITU. 601 standard or an ITU. 656 standard.

12. The projection system of claim 9, wherein said internal digital video signal comprises television image standards being in accord with a NTSC standard, a PAL 50 standard or a PAL 60 standard.

13. The projection system of claim 12, further comprising a notification line connected between said digital video data processing module and said image processing and projecting unit, said digital video data processing module transmitting a notification signal to said image processing and projecting unit via said notification line to notify said image processing and projecting unit of which image standard is being used in said internal digital video signal.

14. The projection system of claim 13, wherein said notification signal comprises two bits.

15. The projection system of claim 9, wherein said projection system is a projector.

16. The projection system of claim 9, wherein said projection system is a rear projection television.
